(19) United States
(12) Patent Application Publication
(10) Pub. No.: US 2022/0351134 A1
(43) Pub. Date: Nov. 3, 2022

(54) MAIL PIECE PROCESSING SYSTEM, APPARATUS AND METHOD

(71) Applicant: Escher Group (IRL) Limited, Dublin (IE)

(72) Inventors: Icaro Vendrami, Dublin (IE); Paul Guihen, Dublin (IE); Seth Dillen-Seibel, Dublin (IE)

(21) Appl. No.: 17/730,661

(22) Filed: Apr. 27, 2022

(30) Foreign Application Priority Data
Apr. 30, 2021 (GB) 2106246.8

(51) Int. Cl. G06Q 10/08

(52) U.S. Cl. CPC G06Q 10/08355

(57) ABSTRACT

A mail piece processing system comprises:
a processing resource; and
a user interface comprising an arrangement of selectable elements, each selectable element representative of a different destination for a mail piece, wherein
at least some of the destinations represented by the selectable elements are determined for inclusion in the arrangement based on activity over a time period, and
the processing resource is configured to receive user input selecting one of the selectable items, and to perform at least one mail piece processing action based on the user input.

### CROSS-REFERENCE TO RELATED APPLICATIONS

The present application claims the benefit of United Kingdom Patent Application Serial No. 2106246.8, which was filed on Apr. 30, 2021, which is hereby incorporated by reference.

### FIELD

The present invention relates to a mail piece processing system and method.

### BACKGROUND

Post offices and other establishments that handle large volumes of post, for example partner organisations operating on behalf of the post office, mail rooms or merchants, may have any of a variety of systems for processing, charging for and directing post.

For example, in a post office a user, such as a clerk or other operative or a customer themselves, may use a computerised system having pre-defined workflows to handle the processing of a particular mail piece, for example, a parcel, letter or package. When parcels, letters or packages are presented for international shipments the user follows a series of steps to specify the type, weight, dimensions and destination. Following this, the various shipment options are offered to the customer complete with price and any additional options (e.g. insurance). The customer selects and pays for their chosen service. When the destination is captured a list of countries is presented to select from, or to search if the country option is not immediately presented.

The time allowed for processing of individual mail items in a post office environment can be very limited, and any time and efficiency savings that may be achieved are important, for example both for operational efficiencies and customer experience. Even savings of a few seconds for individual mail items can be significant both from a technical, process flow, perspective and from a commercial perspective in situations where a partner is paid commission per mail item processed.

Although postal processing systems are known that include at least some pre-set lists of parameter values to enable rapid selection and processing, such lists are generally static and may not be useful for all post offices or other establishments, given that the nature of postal transactions that are processed in practice may vary significantly.

### SUMMARY

In a first aspect of the invention there is provided a mail piece processing system comprising
a processing resource; and
a user interface comprising an arrangement of selectable elements, each selectable element representative of a different destination for a mail piece, wherein
at least some of the destinations represented by the selectable elements are determined for inclusion in the arrangement based on activity over a time period, wherein
the processing resource is configured to receive user input selecting one of the selectable items, and to perform at least one mail piece processing action based on the user input.

The processing resource may comprise a processor or a plurality of processors. The system may comprise at least one terminal and/or at least one server. The processing resource may be provided in the terminal or one of the terminals, and/or in the server or at least one of the servers. The processing resource may be distributed across different devices. The terminal may comprises a memory, an input device to enable an user to input data, for example a keyboard and/or mouse, and a display device, for example a display screen, configured to display the user interface.

The processing resource may comprise a plurality of modules or circuitries each configured to perform respective processes, for example a workflow management module or circuitry for managing a mail piece workflow, a favourites destination module or circuitry configured to determine and/or select and/or receive favourites destinations, and a user input module or circuitry configured to receive user input and to perform actions in response to the user input.

The user interface may be configured such that further destinations are selectable via a text box, drop-down menu, linked screen or other element of the user interface.

The selectable items may be ordered on the user interface based on the determined activity.

The arrangement may comprise a favourite destinations list.

The system may comprise a plurality of terminals at a location each comprising the processing resource and the user interface, and a further processing resource, or one or more of the terminals, may be configured to determine the destinations to be represented by the selectable elements based on determined activity at the location. The further processing resource may comprise a server, for example a local server or remote server.

The determined activity may comprise the number of selections of the destinations over the time period.

The time period may consist of a plurality of sub-periods and the determined activity may comprise, for each destination, the number of sub-periods for which there was at least a threshold number of selections of the destination.

The threshold number of selections may be one selection.

Each sub-period may comprise a day or a selected or pre-determined number of days.

One or more selected sub-periods may be excluded in determining activity, optionally wherein the sub-periods comprise or are associated with public holidays or events.

An activity score may be generated for the destinations based on activity during said time period. Selecting of the destinations for inclusion in the arrangement may be based on the activity scores.

Different weightings may be applied to activity during different sub-periods of the time period.

The applying of the weightings may comprise giving more weight to more recent activity and less weight to less recent activity.

Different weightings may be applied to activity in respect of different destinations.

The applying of the different weightings may be such as to favour one or more of the destinations over other of the destinations when determining which destinations to include in the arrangement of selectable elements on the user interface based on previous activity.

The determined activity may comprise activity by user(s) at a particular location, optionally in a particular region, or within a particular postal district, or at a particular office or other postal facility.

The destinations represented by selectable elements may differ between different locations, in view of different user activity at the different locations. User activity may comprise by user(s) at a plurality of different workstations or other terminals at the location.

The activity may be determined for at least one further time period and the destinations that are selected for inclusion may be updated in response to a change in activity between the time period and the at least one further time period.

The updating of the destinations may comprise replacing, in the arrangement of user selectable elements, a selectable element representing a first destination with a selectable element representing a second, different destination.

The selectable element representing the first destination may, for example, be replaced with a selectable element representing the second, different destination only if a determined activity score for the second destination exceeds the determined activity score for the first destination, or only if the determined activity score for the second destination exceeds the determined activity score for the first destination by a threshold amount.

Activity may be determined for at least one further time period, to determine a change in activity between the time period and the at least one further time period, and to retain a previously-determined ordering of the selectable items optionally even if the change in user activity is such that at least some of the selectable items should be re-ordered if the ordering is based on user activity.

The retaining of the previously determined ordering of the selectable items may comprise retaining at least one of the selectable items at a higher position in the arrangement even if user activity in relation to the destination(s) represented by the at least one selectable items is such that said at least one of the selectable items should be at a lower position in the arrangement.

The user interface may be configured to output an indication to the user in response to a change in the destinations represented by the arrangement of selectable items and/or in response to a change in ordering or other arrangement of the selectable items.

The indication may comprise a visual and/or audible alert. The indication may be provided on the user interface. The indication may comprise display of text and/or a visual indicator. The indication may comprise a visual effect applied to one or more elements displayed on the user interface.

The indication may be output for a predetermined period of time, and/or until cancelled by a user.

The arrangement of selectable elements may comprise at least one selectable element that represents at least one fixed or pre-determined destination.

The user interface may further comprise at least one further element that enables a user to select at least one further destination that is not represented by the arrangement of selectable items.

The at least one further element may comprise at least one of a search box for inputting of text for a destination search, a selectable element that displays a list of further destinations in response to selection, a list of further destinations, and/or a link to a further screen or window of the user interface that displays selectable elements representing further destinations.

The destinations may comprise countries.

The system may further comprises at least one of a payment terminal, a scale, a barcode reader or other reader device, a printer, a customer display unit (CDU), a cash drawer, and/or a dimensioner, for example operable by the processing resource.

The at least one mail piece processing action may comprise at least one of:
performing a marking action with respect to the mail piece;
outputting pricing information;
printing a receipt or invoice;
routing the mail piece.

The mail piece may comprise a letter, packet or parcel.

Each selectable item may comprise at least one of a button, tick box or selectable entry, for example a selectable entry on a form. The form may be an electronic form provided on a screen or window.

The arrangement may comprise a list or ordering of the selectable items, optionally an ordering in a vertical or horizontal direction on the user interface.

In a further aspect, which may be provided independently, there is provided a method comprising determining at least some destinations to be represented by an arrangement of selectable elements of a user interface of a mail piece processing system, based on determined activity over a time period.

In a further aspect, which may be provided independently, there is provided a method comprising receiving user input by selection of a selectable element of an arrangement of selectable elements, each selectable element representative of a different destination for a mail piece, and performing at least one mail piece processing action based on the user input, wherein at least some destinations represented by the selectable elements are determined based on activity over a time period.

In a further aspect, which may be provided independently, there is provided a computer program product comprising computer-readable instructions that are executable by a processor to perform a method as claimed or described herein.

In a further aspect, which may be provided independently, there is provided a processing apparatus configured to determine at least some destinations to be represented by an arrangement of selectable elements of a user interface of a mail piece processing apparatus or system, based on determined activity over a time period.

The processing apparatus may comprise a server, the server for example being configured to provide data representing the determined destinations to the mail piece processing apparatus or system that includes the user interface.

In a further aspect, which may be provided independently, there is provided a mail piece processing apparatus comprising
a processing resource; and
a user interface comprising an arrangement of selectable elements, each selectable element representative of a different destination for a mail piece, wherein
at least some of the destinations represented by the selectable elements are determined for inclusion in the arrangement based on activity over a time period, and
the processing resource is configured to receive user input selecting one of the selectable items, and to perform at least one mail piece processing action based on the user input.

The mail piece processing apparatus may consist of or include one or more of a user terminal, a point-of-sale device, an interactive counter display unit (CDU), a tablet device, or a self-service kiosk or other self-service device, and/or
wherein the processing resource comprises or forms part of one or more programmable computing device(s), one or more processors, a PC, an Android device, a tablet device and/or a mobile device.

In a further aspect there is provided an algorithm that collates usage statistics within a platform that allows for general weighting and/or exponential calculation. This can be used for any list view/selections. Specifically, this may be applied to the list presented to users when selecting the destination country for an international shipment. A user may be presented with the best country options on screen to make it as quick as possible to select the appropriate one.

While the algorithm may be based on the most commonly selected countries it may have characteristics which do not make it to susceptible to change from short lived spikes in certain destinations and it may execute at an office or area level to handle the fact that depending on the local demographic, the most common destinations may change from area to area depending on factors such as the background of the local community or other demographic information. Display of commonly used data may be provided in an efficient manner creating a more streamlined process flow.

Features in one aspect may be applied as features in any other aspect, in any appropriate combination. For example, any one of system, apparatus, computer program product or method features may be provided as any one other of system, apparatus, computer program product or method features.

### BRIEF DESCRIPTION OF THE DRAWINGS

Various embodiments of the invention will now be described by way of example only, and with reference to the accompanying drawings, of which:

FIG. 1 is a schematic diagram of a mail piece processing system according to an embodiment;

FIG. 2 shows a user interface according to an embodiment;

FIG. 3 is a flow chart illustrating in overview a mail piece processing procedure performed by a user using the embodiment of FIGS. 1 and 2; and

FIG. 4 is a flow chart illustrating in overview a determination of a favourite destinations list comprising user selectable elements, for inclusion in the user interface of FIG. 2.

### DETAILED DESCRIPTION

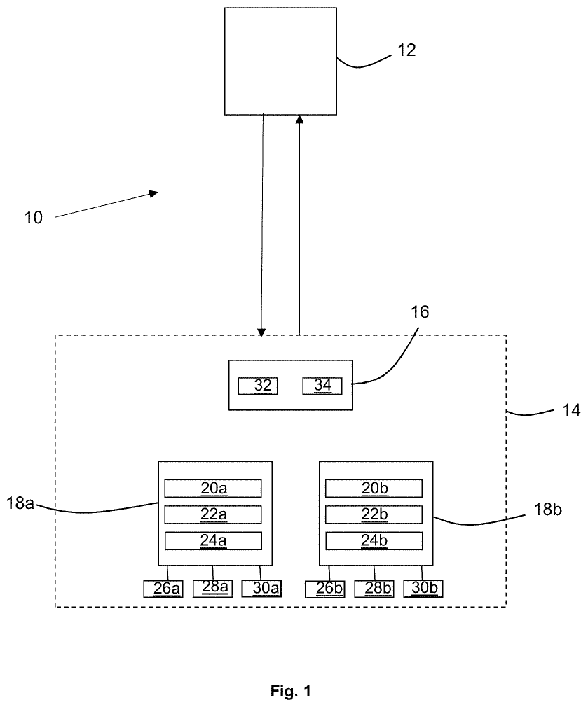

FIG. 1 represents schematically a mail piece processing system 10 according to an embodiment. The system of FIG. 1 comprises a remote server 12 which is connected to local mail piece processing systems at a plurality of locations via the Internet or other network.

One location, in this case a post office 14, is illustrated schematically in FIG. 1 below but it will be appreciated that the remote server 12 can be connected to many tens, hundreds or even thousands of different post offices for other establishments.

In the embodiment of FIG. 1 the post office 14 includes a local server 16 which is connected via a local network to a plurality of terminals 18a, 18b.

Each terminal 18a, 18b comprises a processing resource 20a, 20b in the form of a processor or set of processors, a memory 22a, 22b, an input device to enable an user to input data, for example a keyboard and/or mouse, and a display device 24a, 24b for example a display screen.

In the embodiment of FIG. 1, each terminal 18a, 18b is also connected to or comprises one or more of a payment terminal, a barcode scanner or other reader device 26a, 26b, scales 28a, 28b, and a printer 30a, 30b. Alternatively or additionally, each terminal is connected to one or more of a customer display unit (CDU), a cash drawer, and/or a dimensioner in some embodiments.

The local server 16 includes a processing resource 32 in the form of a processor or set of processors, and a memory 34. The memory 34 of the local server 16 is used to store data representing mail piece processing transactions as a function of time and including, for example, country or other destination data for each mail piece processing transaction performed using the workstations or other terminals of the post office 14. As discussed further below, this stored local usage data can be used to customize the list of destinations presented to the user when processing mail pieces for the office or other location in question.

The remote server in the embodiment of FIG. 1 is used to distribute software and/or data to the local servers, and to receive data, for example usage data or performance data from the local servers. In other embodiments, a remote server is omitted or is used for any desired processing, management and/or monitoring operations.

In the embodiment of FIG. 1, each of the local server, the central server and the terminals are implemented as a suitably programmed PC, Android device or other computing device, and each includes includes a hard drive and other components of a PC, Android device or other suitable computing device including RAM, ROM, a data bus, an operating system, for example Windows 10®, Android operating system or any other suitable operating system, including various device drivers, and hardware devices including, optionally a dedicated graphics card. In other embodiments, any other suitable computing devices or processing circuitries may be provided, for example one or more ASICs (application specific integrated circuits) or FPGAs (field programmable gate arrays) as well as or instead of the PCs, Android devices or other programmable computing devices.

Communication and transfer of data between the terminals and/or servers can be provided using any suitable networking protocol or other communication protocol, for example UDP. TCP/IP or any other suitable packet-based protocol is used in some alternative embodiments. Any suitable file-based or block-based access protocols may be used in some embodiments. The various memories may be implemented in any suitable fashion, for example using any suitable addressable memory structures and protocols. The memories may include databases under any suitable database system, for example Message Server/Store, to store data.

The processors of the terminals and servers can be programmed or configured in any suitable way to provide desired functionality. For example, in some embodiments the processors may comprise, or be programmed or otherwise configured to provide, a plurality of modules or circuitries each configured to perform respective processes as described in relation to embodiments, for example a workflow management module or circuitry for managing a mail piece workflow, a display module or circuitry for controlling a display device to display the user interface, a favourites destination module or circuitry configured to determine and/or select and/or receive favourites destinations, and a user input module or circuitry configured to receive user input and to perform actions in response to the user input. A favourites algorithm module or circuitry may also be provided to determine favourites destinations using algorithm(s) as described in in relation to embodiments.

Although it has been mentioned that in the embodiment of FIG. 1 the terminals may be implemented as a suitably programmed PC, any other suitable form of terminal may be provided in alternative embodiments. For example, each terminal may comprise or be in the form of a desktop/counter point-of-sale device, an interactive counter display unit (CDU), a tablet device, or a self-service kiosk or other self-service device. Whilst the terminals in many embodiments are in fixed positions in other embodiments the terminals may comprise mobile devices, for example tablets, and may for example be moved within the post-office or other location.

Each terminal 18a, 18b is configured to display and manage a workflow via a user interface displayed to the user on the display 24a, 24b. For example, each terminal 18a, 18b includes a program stored in memory 22a, 22b that upon execution by the processor 20a, 20b causes the display of the user interface and management of interaction with an user via the user interface.

The user interface provides interactive data display and entry to enable a user to perform mail piece processing operations, for example to enable a user to manage interaction with the customer and/or to ensure that a mail piece, for example a letter, package or parcel, is processed correctly. In some embodiments the user may be the customer and the terminal may be a self-service terminal.

The workflow can include selecting a destination, selecting one or more mailing options (for example normal delivery express delivery recorded delivery), weighing or determining the size of the mail piece, obtaining and/or presenting pricing information, indicia or otherwise marking the mail piece, printing or otherwise outputting stickers or stamps for attachment to the mail piece, and generating receipts or other documentation for the customer or other user and/or for the post office 14.

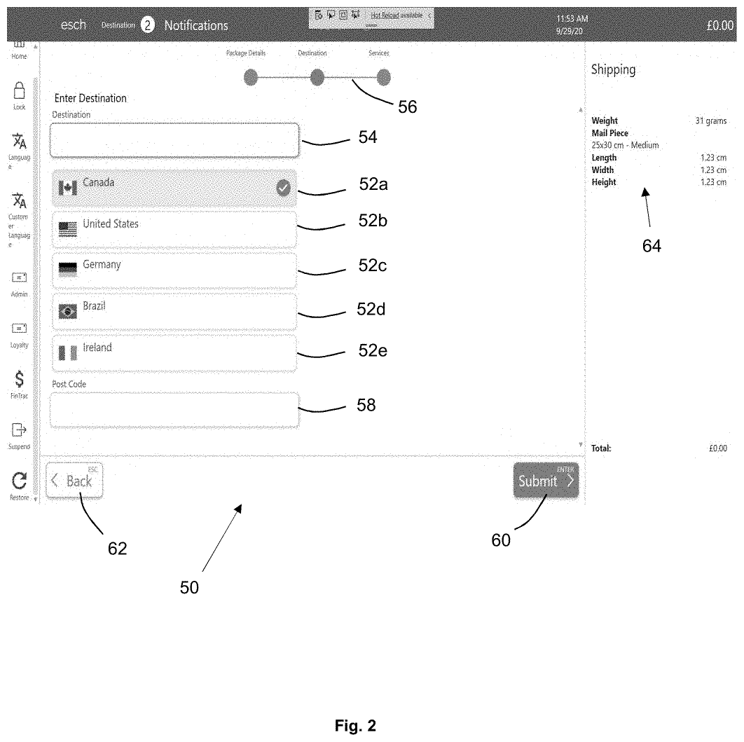

A user interface 50 that is generated by the processor 20a, 20b and displayed on the display device 24a, 24b as part of the workflow of the embodiment of FIG. 1 is shown in FIG. 2. The user interface of FIG. 2 is used to enable a user to enter a destination, for example country, to which the customer wishes the mail piece to be sent, as part of the workflow.

In the embodiment of FIG. 1 the workflow consists of a series of interlinked screens or windows provided, or forming part of, the user interface 50, configured so that the user can select or enter data relating to provide suitable processing of mail piece(s), for example letters or packets, presented by a customer. The user moves through the workflow by navigating through the interlinked screens or windows.

The user interface window shown in FIG. 2 includes an arrangement of selectable elements 52a-52e each selectable element representative of a different destination for a mail piece. In the example shown in FIG. 2, the destinations are particular countries, in this case Canada, United States, Germany, Brazil and Ireland. The selectable element arrangement 52a-52e shown in FIG. 2 can also be referred to as a favourites list or a favourite destination list.

A text box 54 is also provided by the user interface 50, in which the user can enter the names or parts of the names of other countries, if a destination country requested by the customer is not included in the favourites list or other arrangement of selectable elements 52a-52e. The text box 54 can be linked to a search operation to enable the searching for the desired country, and/or can include auto complete function and/or in some embodiments is replaced or supplemented by a drop down menu and/or a list of further destinations, and/or a link to a further screen or window of the user interface 50 that displays selectable elements representing further destinations. In other embodiments, any other suitable element that enables a user to select at least one further destination that is not represented by the favourites list may be provided.

The window of the user interface 50 shown in FIG. 2 also include a box 58 for entry of a post code if desired, or required, and buttons 60, 62 whose operation moves the workflow either backwards or forwards to other windows or screens of the user interface. A graphical representation 56 of progress through the workflow is also provided. At least one earlier screen or window of the workflow is used by the user to input or otherwise obtain, for example by way of operation of the scales or other device, size and weight information for the mail piece, and such size and weight information that has been obtained is displayed at area 64 of the interface in this embodiment.

In the embodiment of FIG. 2, the selectable elements 52a-52e comprise selectable areas or buttons that can be selected by the user positioning a mouse pointer or other tool over the selectable area or button and clicking on a mouse button or a key or other input element, thereby selecting the destination associated with the user selectable element for the mail piece processing transaction. Thus, for example a destination may be selected by way of a one-click process. Any other suitable selectable elements, for example tick boxes or selectable entries for instance on a form, and selection techniques can be used in alternative embodiments.

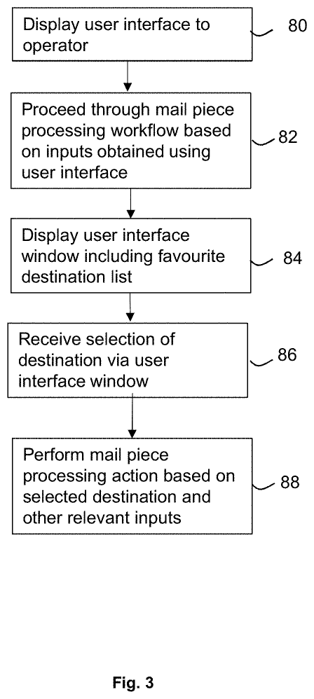

Operation of the system of FIGS. 1 and 2 is illustrated schematically in overview in the flowchart of FIG. 3.

At a first stage 80, the user interface 50 is displayed to the operator on the display device 24a, 24b of one of the terminals 18a, 18b. A customer presents a mail piece to the user and the user at stage 82 proceeds through a mail piece processing workflow based on inputs obtained using the user interface 50 and by navigating through interlinked screens or windows of the user interface 50. In some alternative embodiments the user is the customer and the terminal is in the form of a self-service terminal.

In the embodiment of FIG. 2, the user obtains for example the weight and size of the mail piece (in the example shown in FIG. 2, weight of 31 grams and approximate area of 25×30 cm) for example by operation of scales connected to the terminal 18a and/or by estimation of size or operation of size measuring device.

At the next stage 84, the user interface window including the favourite destination list is displayed to the user on the display device 24a, 24b.

Then, at stage 86, the user enters a selection of destination (e.g. country) by selecting one of the user-selectable elements 52a-52e or by entry into the text box 54 or other element. In the present example, the user selects USA as the destination country by positioning a mouse pointer over the corresponding user selectable element 52b and operating a mouse button.

At the next stage 88, the processor 20a, 20b then performs or controls performance of, for example as part of the workflow, at least one mail piece processing action based on, for example in response to, the user input selecting the selectable item e.g. selecting based on the selected destination.

In the embodiment of FIG. 2, the at least one mail piece processing action comprises outputting pricing information, based on the selected destination and any other relevant inputs or selected options (e.g. normal delivery, express delivery, or recorded delivery; weight and/or size of mail piece), printing a receipt or invoice representing the pricing information, and/or performing a further printing operation to mark the mail piece with one or more indicia for example once payment has been received from the customer. The indicia may represent the selected destination and/or may indicate that suitable payment has been received to enable sending to the selected destination. In other embodiments, any suitable mail piece processing actions or combination of actions may be performed based on the selected destination or other input. For example, in some embodiments a routing operation may be performed in which the processor 20a, 20b controls an electro-mechanical apparatus for physically routing the mail piece to a particular maul chute or sack or other container for containing mail intended for a particular destination or set of destinations (e.g. domestic, foreign).

Returning to details of the user interface 50, it is a feature of the embodiment that the countries represented on the selectable element list 52a-52e, also referred to as the favourites list, are selected for inclusion based on activity over a previous time period, for example the number of selections of the destinations over the time period. Any suitable time period can be used for example one week, one month, three months, six months, or one year.

It is a feature of the embodiment of FIG. 2 that the countries represented on the favourites list are selected by monitoring and recording the various destinations selected within the local post office 14 (e.g. selected via terminals 18a, 18b over the determined time period). In this embodiment, an algorithm used to select the destinations for inclusion on the favourites list runs against the aggregate of transactions within the office and not at the individual or terminal level as the destination will be determined by the demographic of the office and not the individual clerk or counter position.

In the embodiment of FIG. 2, the list presented to the clerk, customer or other user is presented in the following order:—
1. Domestic (Canada in this example)
2. A static and defined/configured list of normally most common destinations. For example in Canada this would be the USA as the majority of international shipments from Canada are always to the USA.
3. The dynamic predictive list that presents in order of popularity the most common destinations over a defined recent period of time and not skewed by outliers on any specific day. In this example, the destinations are Germany, Brazil and Ireland.

The result of this is that in the majority of destinations that are commonly used for post from a given post office or other location may be predicted and displayed on screen for a clerk, customer or other user to single click/select using the user selectable elements 52a-52e and if the destinations change over time then the list displayed onscreen will eventually reflect this.

In the embodiment of FIG. 2, the selectable items are in a list ordered in a vertical direction, with the most significant destinations highest in the list. In alternative embodiments any other desired arrangement may be provided, for example the selectable items may be arranged in a horizontal direction or in any desired pattern, with ordering in the list or pattern being determined based on relevance or importance or based on user input or in any other desired manner.

The user interface 50 of the embodiment of FIG. 2, or variants of the embodiment, can include some or all of the following features:
a) It displays destinations in a favourites list respecting the order of per result provided by the algorithm.
b) It allows immediate search to any other destination in an input displayed on top of the list.
c) In some variants it allows enabling a button or other element above or underneath the list, which sends the operator to another modal screen where another destination can be also searched.
d) To search for another destination the operator types characters in the or an input box and a dropdown list is displayed.
e) When a new destination is searched and selected, the destination at the bottom of the list is replaced by the new one.
f) Another, optional, feature is the generation of a notification when the destinations represented in the list of user selectable elements changes, for example so the clerk or other user is aware they need to pay increased attention.

In the embodiment of FIG. 1, the algorithm that selects the destinations to be represented by the user selectable elements 52a-52e of the favourites list is run by the processor 32 of the local server 16. The results of the algorithm are stored at the local server 16 and distributed to the individual workstations or other terminals 18a, 18b for display via the user interface 50 of FIG. 2. The terminals may for example be operator terminals for use by a clerk or other operator, or self-service terminals for use by customers.

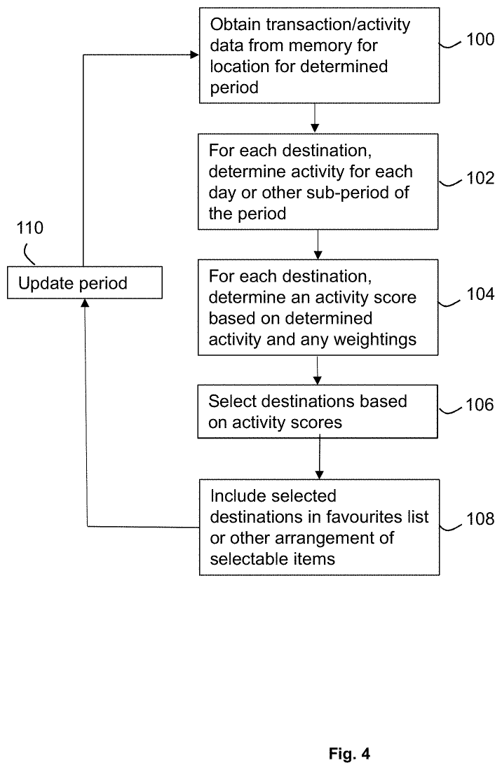

The determining of the favourites list 52a-52e, or other arrangement of user selectable elements representing destinations by application of the algorithm is described in overview with reference to the flow chart of FIG. 4.

The memory 34 of the local server 16 stores data representing mail piece processing transactions as a function of time (for example, by day or date) and including, for example, country or other destination data for each mail piece processing transaction performed using the workstations or other terminals 18a, 18b of the post office 14.

At a first stage 100, the processor 32 of the local server 16 obtain transaction/activity data from the memory 34 for the location, in this case the post office 14, for a predetermined or selected period, in this example a 3 month period.

At the next stage 102, the processor 32 applies the algorithm to the data to determine for each destination (in this example, each possible destination country) activity for each day or other sub-period of the period (in this example, the preceding 3 month period). Any suitable determination of activity can be used. In certain embodiments, as discussed further below, the measure of activity is whether on a particular day there is at least one mail piece transaction for a particular destination (e.g. a particular country).

At the next stage 104, the processor uses the algorithm to determine, for each destination (e.g. each destination country) an activity score based on determined activity and any weightings. Examples of calculation of activity score and use of weightings in certain embodiments is discussed further below.

At the next stage 106, destinations are selected based on the determined activity scores. For example, five or any other suitable selected number of destinations (e.g. destination countries) may be selected, for instance between 2 and 10 destinations, between 3 and 6 destinations, and/or a user-selected number of destinations.

At the next stage 108, the selected destinations are included in a favourites list 52a-52e or flagged for inclusion in such list.

At the next stage 110, when a selected time has passed, or in response to any other desired criteria, the time period in respect of which the algorithm is applied is updated, the processor 32 returns to stage 100 and the calculation of the destinations for selection for inclusion in the favourites list is repeated.

In some embodiments the processor 32 of the local server 16 repeats the process of FIG. 4 either continuously or periodically, for example once per day or once per week, to determine whether updates of the countries represented by the user selectable elements 52a-52e are required in view of recent activity, for example based on a change in activity between a time period and a further, later time period. Thus, effectively each day or week or at any other selected interval, the processor 32 determines activity for a further time period which includes the current or immediately preceding day or week and excludes the last day or week of the previously used time period (i.e. the time period of the previous day's or week's calculation) and determines the selectable items to be included in the favourites list and their ordering, for example using the algorithm.

The destination selection algorithm in the embodiment of FIG. 2, or variants of the algorithm, provides at least one, some or all of the following features:
a) It ranks most frequent destinations based on occurrences, where >0 transactions represent 1 occurrence and 0 transactions represent no (0) occurrence.
b) It applies at least one weighting factor in respect of each record based on most important data points pre-configured and provided as input.
c) It limits the number of records returned given input configuration.
d) It maintains the same order of records as per previous returned list.
e) In case previous returned list does not exists, it orders records descending by adjusted weight applied for each record.

In further detail, the algorithm in the embodiment of FIG. 2, also referred to as a Ranking Destinations algorithm, is an algorithm that, given a set of data points (e.g. representing mail piece processing transaction as a function of date or other time measure and including, for example, country or other destination data), will establish the favorite ones (e.g. most commonly encountered countries or other destination) based on how frequent a determined record (e.g. a particular destination country) is encountered within a range of data points.

The frequency (F) can be calculated by counting the occurrences (O) of all data points (D) over a determined period (X) and rank the top ones (Y), or:

F=(O1+O2+O3+ . . . OX), where:

X is the number of sub-periods (e.g. number of days or weeks) defined in settings.

Y is the number of records that should be returned.

D the data points sample.

O is the occurrence or not occurrence (e.g. of a particular country or other destination) for a specific day, where: 1 is a true occurrence and 0 or not existent is not an occurrence.

It is a feature of the embodiment of FIG. 2 that the algorithm does not sum the amount of transactions for each day or other sub-period (although this can be done in other, alternative embodiments). Instead it gives an occurrence value of 1 for a day, or other sub-period, and destination if there is at least one transaction for that destination ((e.g. one transaction is used as a threshold number of selections of the destination) on that day or other sub-period, and an occurrence value of 0 if there is no transaction for that destination on that day or other sub-period. In alternative embodiments, any other threshold number of selections of a destination for a particular sub-period can be used, rather than one selection being used as the threshold number for determining what occurrence value should be assigned to the sub-period (e.g. day) and destination.

In the embodiment of FIG. 2, if data is absent for a particular destination for a particular day or other sub-period then it is considered as not existent and an occurrence value of 0 is given for that destination for that day or other sub-period.

In some modes of operation, or embodiments, in determining activity for a particular day or other sub-period, for example whether a destination should be given an occurrence value of 1 or 0 for a particular day or other sub-period, certain days or other sub-periods are excluded, for example public holidays or other days when it may be expected that postal activity may be exceptional or atypical, or when the post office or other establishment is closed, or only open for reduced hours or operating a reduced service.

The algorithm applies a specific weight to some pre-determined records (P) e.g. some pre-determined destinations. This is the case in certain embodiments where specific records (e.g. some specific destinations) are considered more important than others by definition and therefore need to be favoured and/or rank better (for example, the domestic country, e.g. the country where the post office is located, and countries neighbouring that country are more important in the embodiment therefore should rank better). P in this embodiment represents the list of records (e.g. destinations) to which weights are applied to encourage those records to be selected and included in the arrangement of selectable items (e.g. favourite destinations) on the user interface 50.

In some embodiments, particular destinations are fixed or pre-determined as being included in the favourites destination list, or other arrangement of selectable items, without using weightings or determining activity. For example, for the list of countries shown in FIG. 2 in some alternative embodiments Canada, as the domestic territory, and the US, as the nearest neighbour, are always included in the favourites list regardless of activity. In some such embodiments a user can select such fixed destinations, thus allowing user-selected customization of the favourites list for a particular post office or other location, and/or for a particular user or workstation.

In certain embodiments, weightings are not used at all. In other, alternative embodiments, different weightings are applied to different sub-periods, for example different days, during the period so that, for example, more weight is given to more recent activity and less weight is given to less recent activity. Thus, for example, activity in more recent days may contribute more to an activity score than the same level of activity in less recent days.

Once the scores are calculated for each sub-period (e.g. each day) and summed across the period (e.g. the preceding 3 months) for each record (e.g. each destination), and any weightings to the summed scores have been applied, either before or after the summing, the records (e.g. the destinations) are ranked based on the summed scores. The summed scores may be referred to as activity scores. Any other suitable method for determining activity scores may be used in alternative embodiments.

In case there is a draw (i.e. multiple records (e.g. destinations) with the same score) and there's no space left in the final list (e.g. two destinations or other records both have the same score and are ranked joint fifth, with five destinations to be provided in the favourites list of user-selectable elements 52a-52e representing destinations) the algorithm of the embodiment selects the record (e.g. destination) that is already on the list. If that does not help distinguish between the records then either a random selection, or selection based on geographical distance or alphabetical order, can be used to select one of the tied records, or in some embodiments the size of the favourites list can be increased.

One or more, or all, of the following features are provided in some embodiments to discourage the destinations or other records provided on the favourites list on the user interface from changing rapidly e.g. from day-to-day or week-to-week.
As discussed in the preceding paragraph, use the fact that a particular destination is already on the favourites list as a tie-breaker if two or more destinations have the same score. If there was a tie amongst destinations, in this embodiment select the one that is already in the favourites list.
In some embodiments, apply to the scores weightings favouring selection of destinations or other records that are already on the favourites list. This can make it harder for an existing destination on the favourites list to be replaced on the favourites list by another destination.
Preserve order of the destinations or other records on the favourites list in a previously-determined order, even if the scores change when calculated for a further time period (e.g when the algorithm is re-run each day or week or at any other selected interval) and indicate the destinations should be re-ordered if ordering based only on score or other measure of user activity. For example, if a destination went from second highest to fifth highest on the list, nevertheless continue to include it at second position on the favourites list on the user interface. Thus, at least one of the selectable items may be retained at a particular position, for example a higher position, in the arrangement even if user activity in relation to the destination(s) represented by the at least one selectable items is such that said at least one of the selectable items should be at a lower position, or other different position, in the arrangement.

The features in the immediately preceding list can help to prevent the content and ordering of the favourites list from changing rapidly. This can be helpful for the user, and can provide improved efficiency, as the user may be accustomed to the selectable elements representing particular destinations being included and being present at particular locations on the user interface, enabling particularly rapid selection of those destinations by the user.

In some embodiments, a selectable element representing a particular destination on the favourites list or other arrangement is replaced with a selectable element representing a second, different destination only if a determined activity score for the second destination exceeds the determined activity score for the destination, or only if the determined activity score for the second destination exceeds the determined activity score for the destination by a threshold amount.

Once the ranking of the summed, weighted scores has been calculated and other rules, such as those discussed above, have been applied, the processor 32, implementing the algorithm, selects the destinations or other records to be included on the favourites list to be represented by the user selectable elements 52a-52e representing those destinations on the user interface 50.

According to the embodiment of FIG. 2, the following conditions apply to the favourites list output:
a) the total number of records included in the favourites list is equal to int:NumberOfRecordsToReturn, where int:NumberOfRecordsToReturn is an integer parameter having a value that is either pre-set or selected by a user;
b) the order of the favourites list is the same as per PreviousResult, where PreviousResult is data representing the destinations or other records currently provided on the favourites list and their order on the favourites list. In some embodiments, the PreviousResult data can have default values (e.g. there is a default set of favourites destinations) that are used until sufficient local transaction data is recorded, for example by the local server 16, to enable the favourites list to be updated based on that local transaction data. In some embodiments the default values (e.g. the default list of destinations and their order in the favourites list) can be set by a user, for example locally for the particular post office 14 or other location or centrally via the remote server 12.

The calculating of the destinations or other records to be included in the favourites list, and their order, is repeated on any suitable basis, for example periodically (e.g. every day, every week, every month or a user-selected period) or on command of a user.

In some embodiments, the terminal 18a, 18b outputs an indication to the user, for example via the user interface 50 in response to a change in the destinations represented by the arrangement of selectable items and/or in response to a change in ordering or other arrangement of the selectable items. The user may, for example be a clerk or other operator or, if the terminals are in the form of self-service terminals, a customer who wishes to send one or more mail pieces.

Any suitable indication of a change can be provided, for example a visual and/or audible alert, optionally a display of text (e.g. a message indicating there has been a change) and/or a visual indicator and/or a visual effect applies to one or more elements displayed on the user interface 50. For example, in some embodiments if there has been a change to the favourite destination list a change in colour, a flashing effect or other visual effect may be applied to or near the list, or one or more elements of the list, as well as or instead of a message to the user. An audible alert may also be provided. The indication may be output for a predetermined period of time, and/or during a predetermined number of transactions and/or until cancelled by a user.

Embodiments have been described in which a favourites lists of destinations, or other arrangement of user-selectable elements representing destinations, is generated based on activity at a particular post office, for use at that post office. In other embodiments tailored favourites lists, or other arrangement of user-selectable elements, may be generated based on activity at any suitable location(s) for example for a particular region, or within a particular postal district, or at a particular office or other postal facility, for example for subsequent use at such locations. Thus, the favourites lists, or other arrangement of user-selectable elements, generated for particular locations may be different from those generated for other locations based on different activity at the different locations.

References have been made to interactions between a user and a customer. References to customers also encompass references to any other suitable users according to embodiments. In certain embodiments user may process transactions using the system, without direct interaction with a customer. For example a user may be provided with a set of mail pieces and associated data and process mail piece transactions for the mail pieces based on the associated data.

In some embodiments the terminals are in the form of self-service terminals, and the user may be a customer who uses one of the terminals in respect of one or more mail pieces that the customer wishes to send. Thus, in such embodiments a mail processing operation may be performed by a customer without the intervention of a clerk or other operative.

Although in certain embodiments described herein, a local server is used to determine destinations to be included in a favourites destination list for a post office or other location, based on activity at that post office or other location, in other embodiments destinations to be included in the favourites list can be determined in any other manner, for example by a remote server, or by any one or more of the user terminals or other workstations, or by any other processing resource for example a cloud-based processing resource or other distributed processing resource. In some embodiments, activity from locations other than the location in question, may also be used. For example, the favourites list may be determined based on activity across a network of post offices. For instance, the favourites list for a post office or other location may be determined based on activity across a plurality of post offices or other locations, but with activity at said post office or location being given greater weighting. In some embodiments the favourites list for a post office or other location may be determined based on activity at that post office or other location, but certain fixed destinations always to be included (e.g. domestic country and a near-neighbour country) may be selected centrally or remotely.

In some embodiments the remote server 12 includes a central database that stores data for all post offices or other locations, and the remote server 12 determines the favourites destination list for a particular post office or other location based on activity for that post office or other location obtained from the central database, using algorithms as described herein, and then sends the favourite destinations data to the post office or other location, either to a local server at the location or to user terminals directly. In some such embodiments, no local server is provided and communication is directly between the terminals and the remote server.

Whilst particular functionalities have been described herein as being provided by servers and terminals, in alternative embodiments functionality can be provided by a single processing resource, circuitry or other component, or functionality provided by a single processing resource can be provided by two or more processing resources, circuitries or other components in combination. Reference to a single circuitry and/or processing resource encompasses multiple components providing the functionality of that circuitry and/or processing resource, whether or not such components are remote from one another, and reference to multiple circuitries and/or processing resources encompasses a single component providing the functionality of those circuitries and/or processing resources.

Various functionalities as described can, in particular embodiments, be provided as modules obtained by operation of software and/or in hardware. For example, an activity module and a favourites destination module may determine activity for different destinations, and calculate destinations for inclusion in a favourites list respectively. A workflow module may control workflows as described, based at least in part on user or other input.

A skilled person will appreciate that variations of the described embodiments are possible without departing from the invention. Accordingly, the above description of the specific embodiments is made by way of example only and not for the purposes of limitation. It will be clear to the skilled person that minor modifications may be made without significant changes to the operation of particular embodiments described.

1. A mail piece processing system comprising
a processing resource; and
a user interface comprising an arrangement of selectable elements, each selectable element representative of a different destination for a mail piece, wherein
at least some of the destinations represented by the selectable elements are determined for inclusion in the arrangement based on activity over a time period, and
the processing resource is configured to receive user input selecting one of the selectable items, and to perform at least one mail piece processing action based on the user input.

2. A system according to claim 1, wherein the user interface is configured such that further destinations are selectable via a text box, drop-down menu, linked screen or other element of the user interface.

3. A system according to claim 1, wherein the selectable items are ordered on the user interface based on the determined activity.

4. A system according to claim 1, wherein the system comprises at least one terminal at a location, the or each terminal comprising the processing resource and the user interface, and wherein a server or other further processing resource, or one or more of the terminals, is configured to determine the destinations to be represented by the selectable elements based on determined activity at the location.

5. A system according to claim 1, wherein the determined activity comprises the number of selections of the destinations over the time period.

6. A system according to claim 1, wherein the time period consists of a plurality of sub-periods and the determined activity comprises, for each destination, the number of sub-periods for which there was at least a threshold number of selections of the destination.

7. A system according to claim 6, wherein at least one of a) and/or b):
a) the threshold number of selections is one selection;
b) each sub-period comprises a day or a selected or pre-determined number of days.

8. A system according to claim 1, wherein one or more selected sub-periods are excluded in determining activity.

9. A system according to claim 1, wherein an activity score is generated for the destinations based on activity during said time period and selecting of the destinations for inclusion in the arrangement is based on the activity scores.

10. A system according to claim 9, wherein different weightings are applied to activity during different sub-periods of the time period and/or different weightings are applied to activity in respect of different destinations.

11. A system according to claim 10, wherein the applying of the weightings comprises giving more weight to more recent activity and less weight to less recent activity.

12. A system according to claim 10, wherein applying of the different weightings is such as to favour one or more of the destinations over other of the destinations when determining which destinations to include in the arrangement of selectable elements on the user interface based on previous activity.

13. A system according to claim 1, wherein at least one of a) and/or b):
a) the determined activity comprises activity by user(s) at a particular location and/or within a particular postal district, and/or at a particular office or other postal facility;
b) the destinations represented by selectable elements differ between different locations, in view of different user activity at the different locations.

14. A system according to claim 1, wherein the activity is determined for at least one further time period and the destinations that are selected for inclusion are updated in response to a change in activity between the time period and the at least one further time period.

15. A system according to claim 14, wherein the updating of the destinations comprises replacing, in the arrangement of user selectable elements, a selectable element representing a first destination with a selectable element representing a second, different destination.

16. A system according to claim 1, wherein activity is determined for at least one further time period, to determine a change in activity between the time period and the at least one further time period, and to retain a previously-determined ordering of the selectable items even if the change in user activity is such that at least some of the selectable items should be re-ordered if the ordering is based on user activity.

17. A system according to claim 16, wherein the retaining of the previously determined ordering of the selectable items comprises retaining at least one of the selectable items at a higher position in the arrangement even if user activity in relation to the destination(s) represented by the at least one selectable items is such that said at least one of the selectable items should be at a lower position in the arrangement.

18. A system according to claim 1, wherein the user interface is configured to output an indication to the user in response to a change in the destinations represented by the arrangement of selectable items and/or in response to a change in ordering or other arrangement of the selectable items.

19. A system according to claim 18, wherein at least one of:
the indication comprises a visual and/or audible alert;
the indication is provided on the user interface;
the indication comprises display of text and/or a visual indicator; and/or
the indication comprises a visual effect applies to one or more elements displayed on the user interface.

20. A system according to claim 1, wherein the arrangement of selectable elements comprises at least one selectable element that represents at least one fixed or pre-determined destination.

21. A system according to claim 1, wherein the user interface further comprises at least one further element that enables a user to select at least one further destination that is not represented by the arrangement of selectable items.

22. A system according to claim 21, wherein the at least one further element comprises at least one of a search box for inputting of text for a destination search, a selectable element that displays a list of further destinations in response to selection, a list of further destinations, and/or a link to a further screen or window of the user interface that displays selectable elements representing further destinations.

23. A system according to claim 1, wherein at least one of a), b), c), and/or d):
a) the destinations comprise countries;
b) the mail piece comprises a letter, packet or parcel;
c) each selectable item comprises at least one of a button, tick box or selectable entry on a form;
d) the arrangement comprises a list or ordering of the selectable items.

24. A system according to claim 1, wherein the system further comprises at least one of a payment terminal, a scale, a barcode reader or other reader device, a printer, a customer display unit (CDU), a cash drawer, and/or a dimensioner, and/or wherein the at least one mail piece processing action comprises at least one of:
performing a printing or other marking action with respect to the mail piece;
outputting pricing information;
printing a receipt or invoice;
routing the mail piece.

25. A method comprising receiving user input by selection of a selectable element of an arrangement of selectable elements, each selectable element representative of a different destination for a mail piece, and performing at least one mail piece processing action based on the user input, wherein at least some destinations represented by the selectable elements are determined based on activity over a time period.

26. A computer program product comprising computer-readable instructions that are executable by a processor to perform a method according to claim 25.

27. A processing apparatus configured to determine at least some destinations to be represented by an arrangement of selectable elements of a user interface of a mail piece processing apparatus or system, based on determined activity over a time period.

28. A processing apparatus according to claim 36, comprising a server, the server being configured to provide data representing the determined destinations to the mail piece processing apparatus or system that includes the user interface.

29. A mail piece processing apparatus comprising
a processing resource; and
a user interface comprising an arrangement of selectable elements, each selectable element representative of a different destination for a mail piece, wherein
at least some of the destinations represented by the selectable elements are determined for inclusion in the arrangement based on activity over a time period, and
the processing resource is configured to receive user input selecting one of the selectable items, and to perform at least one mail piece processing action based on the user input.

30. A mail piece processing apparatus according to claim 38, wherein the mail piece processing apparatus consists of or includes one or more of a user terminal, a point-of-sale device, an interactive counter display unit (CDU), a tablet device, or a self-service kiosk or other self-service device, and/or
wherein the processing resource comprises or forms part of one or more programmable computing device(s), one or more processors, a PC, an Android device, a tablet device and/or a mobile device.
